(19) United States
(12) Patent Application Publication
(10) Pub. No.: US 2004/0199440 A1
(43) Pub. Date: Oct. 7, 2004

(54) System and method for the sale and lease-back of governmental assets to private entities

(76) Inventor: James Mark McDaniel JR., Greensboro, NC (US)

Correspondence Address: Karl G. Schwappach, Faegre & Benson LLP, 2200 Wells Fargo Center, 90 South Seventh Street, Minneapolis, MN, 55402-3901, US

(21) Appl. No.: 10/390,282

(22) Filed: Mar. 17, 2003

(51) Int. Cl. G06F 17/60

(52) U.S. Cl. 705/35

(57) ABSTRACT

A high grade investment vehicle, and associated method, for private investors to utilize the investment potential of government assets while simultaneously lowering the cost to the government for use of that asset and freeing cash equity for governmental use for services and/or debt retirement. A sales document transfers title of a governmental asset to a private entity in exchange for funds. The transfer of title converts the governmental asset into a private asset. A general obligation lease between the private entity and the governmental entity grants the governmental entity usage of at least a portion of the private asset in exchange for lease payments. The general obligation lease has the investment risk characteristics of a general obligation bond, but lease payments are less than the debt service on conventional government securities yielding the same amount of funds obtained through the sale of the governmental asset.

### FIELD OF THE INVENTION

The present invention relates to a high grade investment vehicle, and associated method, for private investors to utilize the investment potential of government assets while simultaneously lowering the cost to the government for use of that government asset and freeing cash equity for governmental use for services and/or debt retirement.

### BACKGROUND OF THE INVENTION

Federal, state, and local governments face fiscal pressures to provide services that the public demands with the revenue that it collects through taxes, usage fees and the like. In times of economic downturn, many government entities face severe budget issues, which require the entity to make difficult choices regarding funding, taxation, and deficits. For example, the United States Commerce Department reported that state and local governments borrowed $127 billion more than they repaid in 2002. In fact, borrowed money equaled 9.7% of state and local expenditures in 2002. Debt service on this borrowed money has become an increasing large portion of governmental expenditures, further starving governmental entities of the cash needed to provide services.

Meanwhile governments at all levels have billions of dollars tied up in a variety of assets, such as real estate and other property. Government-owned buildings, which typically house governmental offices, built or purchased at taxpayer expense, represent large pieces of public equity that is presently not available to governmental entities.

Private sector businesses that own commercial real estate will often sell their property and immediately lease it from the new owner in a “sale and lease-back” transaction. A sale and lease-back transaction allows the business to access the capital previously tied up in the asset. The lease payments made to the new property owner are deducted as a legitimate operating expense for income tax purposes. The sale and lease-back transaction provides potential investors with a stable income return on the property as a result of the lease payments, as well as a speculative return based on the potential appreciation of the property.

A well-known type of organization authorized by United States federal law, known as a Real Estate Investment Trust (“REIT”), invests specifically in commercial real estate. While a REIT may invest in any type of commercial real estate properties or debt instruments, including multi-family housing, shopping centers, and office buildings, it may also engage in sale and lease-back arrangements. Congress has created specific regulations regarding the distribution of profits for REITs, requiring, for example, that they distribute all taxable income to investors in the form of dividends.

REITs have been successful because they have three distinct advantages over traditional ownership vehicles for commercial property. First, interests in REITs can be publicly traded, increasing the liquidity of commercial real estate. Second, the value of a REIT is based on the underlying assets it owns, and hence, is typically not as volatile as other types of investments, such as equity instruments in operating companies. Third, REITs are a pass-through entity for income tax purposes and thus avoid potential double taxation.

Such strategies have been proposed for foreign governments that own businesses that are scheduled for privatization. In one version of this scenario, an investor purchases an asset, such as a building from the foreign government, and leases it back to the foreign government. As proposed, the lease would not be backed by any governmental guarantee. If the government defaults on the lease, the private entity would retain title to the property, but would lose the stream of lease payments that would have been due under the lease. Also, bringing an action against a government tenant for default of a lease can be problematic, especially in some foreign countries.

In addition, the purpose of this investment strategy is to maximize the rental income for the owners. It is known that investment in countries with fledgling free-market economies entails a great deal of risk. As such, rental amounts are adjusted to reflect the risk of default. In such a scenario, the lease payments would likely be proportional to the investment grade of bonds issued by such governmental entity. Consequently, such a sale and lease-back scheme would likely be the same as, or even less financially attractive than, conventional debt instruments.

### BRIEF SUMMARY OF THE INVENTION

The present invention relates to a method and system for the sale and lease-back system of governmental assets. A sales document transfers title of a governmental asset to a private entity in exchange for funds. The transfer of title converts the governmental asset into a private asset. A general obligation lease between the private entity and the governmental entity grants the governmental entity usage of at least a portion of the private asset in exchange for lease payments. The general obligation lease has the investment risk characteristics of a general obligation bond, but the lease payments are less than the debt service on conventional government securities yielding the same amount of funds obtained through the sale of the governmental asset.

The general obligation lease allows a governmental entity to reduce the risk a potential investor may assume in a typical sale and lease-back arrangement, thereby allowing the governmental entity to lease the properties back at rates lower that those paid by private entities, while still providing an attractive investment alternative for private entities. During times when interest rates are low, the lease payments operate as a guaranteed stream of income to the private entity. During times of high interest rates, the appreciation of the underlying private asset offsets, at least in part, the opportunity cost of fixed lease payments that pay a return lower than prevailing interest rates. Thus, the present sale and lease-back system provides a competitive return in a variety of market conditions while mitigating certain economic risks.

In one embodiment, the general obligation lease includes a government credit instrument that pledges the full faith and credit of the governmental entity to make the required lease payments to the private entity on the lease. In one embodiment, the government credit instrument is a plurality or series of zero coupon bonds with maturity dates and face values that correspond to the due date and amount of the lease payments. The zero coupon bonds are used to make the lease payments under the lease. In another embodiment, the government credit instrument is a plurality or series of coupon bonds, wherein the coupons have maturity dates and face values that correspond to the due date and amount of the lease payments. The coupons are used to make the lease payments under the lease. The government credit instrument is preferably fully negotiable.

The general obligation lease preferably permits the private entity to transfer all or part of its rights in the private asset and/or the lease to a third party. The general obligation lease also preferably permits the governmental entity to sublease a portion of the lease to a third party or to assign the lease to a third party during the term of the lease.

The general obligation lease can be structured to comply with statutory provisions that allow the governmental entity to pledge the full faith and credit of the governmental entity to make lease payments to the private entity on the lease. In another embodiment, the general obligation lease includes a provision that pledges the full faith and credit of the governmental entity to make lease payments to the private entity on the lease.

The funds paid by the private entity to the governmental entity can be greater than, equal to, or less than the fair market value of the governmental asset. The present sale and lease-back system can also include a tax abatement agreement on the private asset. The tax abatement agreement can be for any term, such as the term of the lease or the life of the private asset. An agreement to waive or reduce tax liability on the lease payments is another mechanism to enhance the value of the private asset and to reduce the cost of the lease to the governmental entity.

The governmental entity can apply the funds from the sale of the governmental asset to general governmental expenditures or to reduce governmental debt.

The private entity can sell equity instruments in the private entity to investors in exchange for capital contributions to the private entity. The private entity can be a plurality of private entities.

The general obligation lease preferably includes a sublease provision that permits the governmental entity to sublease all or a portion of the private asset to a third party, to assign its interest under the lease to a third party, and/or a renewal option that permits the governmental entity to extend the lease for a period of time. The lease can be for the entire private asset or a portion thereof. The lease can be at-will, for a term of years, or otherwise. The lease can optionally include a purchase option that permits the governmental entity to repurchase the private asset and a right of first refusal to lease or purchase the private asset.

### BRIEF DESCRIPTION OF THE SEVERAL VIEWS OF THE DRAWING

FIG. 1 is a schematic illustration of the present sale and lease-back system for governmental assets.

### DETAILED DESCRIPTION OF THE INVENTION

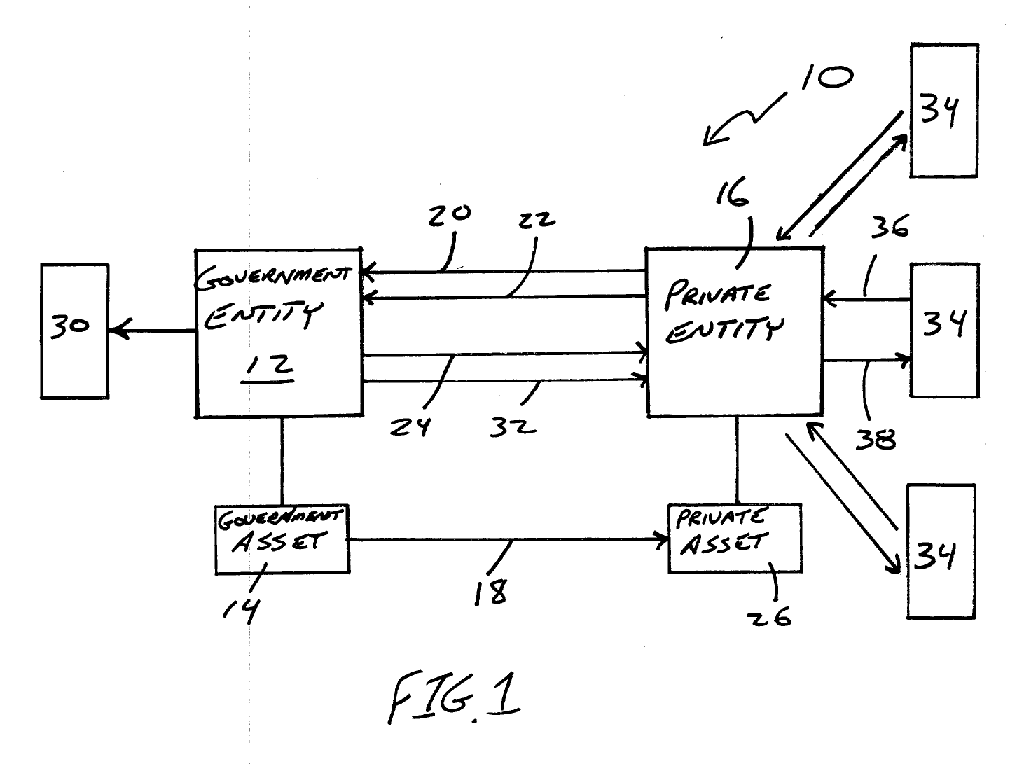

FIG. 1 illustrates one embodiment of a sale and lease-back system 10 in accordance with the present invention. Governmental entity 12 sells a governmental asset 14 to a private entity 16. Title 18 to the governmental asset 14 transfers to the private entity 16. The governmental asset 14 is converted to a private asset 26 owned by the private entity 16. In exchange for transferring title 18 in the governmental asset 14, the governmental entity 12 receives funds 20 from the private entity 16. The governmental entity 12 is then free to use the funds 20 for normal government expenditures 30. As part of the overall transaction, the private entity 16 executes a lease 22 that provides the governmental entity 12 usage of at least a portion of the private asset 26 in exchange for lease payments 24. As will be discussed below, the lease 22 is preferably a general obligation lease in which the governmental entity pledges its full taxing and borrowing powers to performance under the lease 22.

As used herein, “governmental entity” refers to federal, state or local governmental bodies having tax and spend authority, including without limitation cities, counties, airport authorities, port authorities, and economic development authorities. The term “governmental asset” refers to any tangible asset having value, including without limitation developed or undeveloped land, buildings and other structures, equipment, and infrastructure such as roads, bridges, airports, rights-of-way, and the like, owned by a governmental entity. The term “private asset” refers to a former governmental asset that is now owned by one or more private entities.

The terms of the lease 22 depend, at least in part, on the nature of the private asset 26. The lease 22 will typically be for a term of years, but alternatively, it could be a periodic tenancy or a tenancy at will. During the term of the lease 22, the governmental entity 12 will have a right to use, possess, and enjoy the private asset 26 as defined in the terms of the lease 22. At the end of the lease 22 the private entity 16 will have the right to enter into another lease arrangement with the same or a different governmental entity 12, or utilize the private asset 26 in any manner that it chooses, consistent with the applicable rights and obligations of property ownership, including selling the property. The lease can optionally include a purchase option that permits the governmental entity to repurchase the private asset at a stated price or the fair market value.

The funds 20 paid by the private entity 16 to the governmental entity 12 will typically be the fair market value of the governmental asset 14. In another embodiment, the funds 20 are less than the fair market value of the governmental asset 14 in exchange for decreased lease payments 24 over the life of the lease 22. In another embodiment, the funds 20 are more than the fair market value of the governmental asset 14 in exchange for increased lease payments or the private entity 16 receiving preferential tax treatment, as will be discussed below.

The private entity 16 is preferably one or more investment entities created specifically to purchase governmental asset 14 and enter into lease-back arrangements with the governmental entity 12 from which it purchased the property. The “private entity” may be any authorized organization, such as a corporation, partnership, limited liability corporation, trust, real estate investment trust (REIT), and the like. Typically, a REIT may be a corporation or a partnership. While a REIT is a preferred private entity to enter into such sale and lease-back arrangements with the government, it is to be understood that the private entity may be any suitable entity.

The private entity 16 has two potential avenues for a return on its investment. First, the lease payments 24 provide a revenue stream over the life of the lease 22 (or the present value of that revenue stream, should the private entity 16 decide to sell that interest). Second, any appreciation that the governmental asset 14 may realize would be the property of the private entity 16. The private entity 16 also has the right to sell some or all of its interest in the private asset 26 and/or the lease 22 to a third party, subject to the rights granted to the governmental entity 12 in the lease 22.

These sources of return should attract investors 34, which supply capital 36 to the private entity 16. The investors 34 can be individuals or other private entities 16. In return, the private entity 16 sells ownership interests or issues equity instruments 38 to the investors 34. These equity instruments 38 may be bonds, ownership shares, or any other suitable security. The equity instruments 38 of the private entity 16 can preferably be publicly or privately traded.

In one embodiment, the governmental asset 14 is a building in which the governmental entity 12 may only require a portion of the space. The lease 22 can be written to cover only a portion of the building, while the private entity 16, as owner of the building, is free to dispose of the unused space in the open market.

In another embodiment, the governmental asset 14 is land on which a governmental building is situated. The governmental entity 12 sells the land to the private entity 16 in exchange for funds 20. The private entity 16 enters into an extended lease 22 for the land with the governmental entity 12 in exchange for lease payments 24. The governmental entity 12 retains title to the building, but not the underlying land. At the end of the lease 22, title to the building automatically transfers to the private entity 16.

Minimizing Governmental Lease Payments

When an investor engages in a conventional sale and lease-back arrangement with a private corporation, the investor assumes a risk that the corporation will default on the lease. In the event of default, the investor retains title to the property, but loses any future lease payments and may incur significant costs to find another tenant. Therefore, the investor will factor in the risk of default when determining the level of lease payment required to make the investment worthwhile. The greater the risk, the higher the lease payments the corporation will have to pay.

In a conventional sale and lease-back arrangement, in order to attract investors the governmental entity 12 would have to make a lease payment 24 on the lease 22 comparable to that paid by corporations with a high-grade bond ratings. Unfortunately, such lease rates are typically higher than what a governmental entity might pay as interest on conventional governmental bonds. Thus, the governmental entity will likely pay a premium for the capital it raised by a sale and lease-back arrangement in excess of the cost of raising capital by issuing a debt instrument, such as a bond. Therefore, there is little financial incentive for governmental entities to utilize a conventional sale and lease-back arrangement.

Conversely, if the market rate for sale and lease-back arrangements with corporations having high grade bond ratings creates a higher lease rate than what the governmental entity is willing to pay, investors may not be attracted to private entities 16 attempting to engage in a sale and lease-back transaction. What is needed, then, is a method by which the governmental entity 12 can attract investors to participate in the sale and lease-back system 10, while allowing the governmental entity 12 to pay the lowest lease rate that will attract investors.

State and local governments as well as the United States Government have long used their “full faith and credit” to back financial instruments, such as general obligation bonds. A general obligation bond is a debt instrument that is guaranteed by the taxing and borrowing power of a governmental entity. With general obligation bonds, the governmental entity pays interest and principal that amortizes the entire principal balance of the debt. The phrase full faith and credit refers to any security for which a governmental entity pledges its full taxing and borrowing power, plus any revenue other than taxes that it collects to support payment of debt. For example, the State of Minnesota, when issuing a general obligation bond to incur public debt pledges “[t]he full faith, credit, and taxing powers of the state” to repay the principal and interest of the bond. MINN. STAT. 16A.641 SUBD. 1 (2002).

Governmental entities 12 use their full faith and credit to reduce the risk of financial instruments they issue, and hence, reduce the cost of borrowing. Since a governmental entity 12 can bring in future revenue through taxation, the risk that a governmental entity will default on a financial instrument is extremely low, making the financial instrument virtually risk-free. As a result, investors are willing to accept a lower rate of return on a government financial instrument than on a corporate bond from a company with a high-grade bond rating.

In order to minimize the risk to the private entity 16, and hence minimize the cost to the governmental entity 12, the present sale and lease-back system 10 includes a lease 22 that is a general obligation lease. A “general obligation lease” has the investment risk characteristics of a general obligation bond, but lease payments under the lease are less than the debt service on conventional government securities yielding the same amount of funds obtained through the sale of the governmental asset.

The lease payments 24 on the present general obligation lease 22 only have to amortize the difference between the purchase price of the governmental asset 14 and the residual value of the asset 26 at the end of the lease 22, thus lowering the amount paid by the government versus a conventional government bond. In some embodiments, the present general obligation lease 22 has the characteristics of a Real Estate Bonded Investment Trust (“REBIT”). The general obligation lease 22 is guaranteed by the full faith and credit of the governmental entity 12.

Financial Benefits of the Present Sale and Lease-Back System

In the present sale and lease back system 10, the risk that the governmental entity 12 will default on the lease 22 is essentially the same as the risk of default by the governmental entity 12 on a government security. In order to entice the governmental entity 12 to participate, the lease payments 24 will be a function of the cost of obtaining the same amount of funds 20 through conventional government debt instruments, not the fair market value of leasing a comparable private asset. In practice the lease payments 24 will typically be lower than the cost of obtaining the same amount of money through the issuance of a government security because the present sale and lease-back system 10 has at least three significant financial advantages over such government securities.

First, the private entity 16 will realize the benefit of the appreciation on the private asset 26. Since the private entity 16 holds the title 18 to the private asset 26, it is free to sell the private asset 26 at any time, subject to the lease 22 to the governmental entity 12. If the private asset 26 experiences significant appreciation, the private entity 16 is free to cash-out some or all of that equity.

Second, at the end of the lease 22 the private entity can lease the private asset 16 to a non-governmental entity at fair market value, which will likely be significantly higher than the lease payments 24 made by the governmental entity 12. Thus, the private entity has an opportunity for a higher return because it can then lease the property based on commercially competitive rates.

Third, governmental entities commonly waive property tax obligations on buildings used for governmental purposes. The general obligation lease 22 preferably waives or reduces the property tax obligations on the private asset 26 for some period of time. Since the governmental entity 12 was not previously receiving property taxes on the governmental asset 14, there is no net loss of revenue to the governmental entity 12. The property tax abatement is preferably for at least the term of the lease 22, and more preferably, for the life of the private asset 26.

Other mechanisms are also available to further reduce the cost of the lease payments 24. The governmental entity 12 can waive or reduce income tax liability on the lease payments 24 preferably during the term of the lease 22, and more preferably for the life of the private asset 26. Such a waiver is analogous to the use of tax-free status of municipal bonds to attract investors to lower-yield investments. In yet another embodiment, the Federal government can grant preferential tax treatment for lease payments 24 made in connection with the sale and lease-back system 10 of the present invention. Again, such preferential tax treatment reduces the lease payments 24 made by the governmental entity 12 and/or increases the funds 20 received by the governmental entity 12.

With the availability of the present invention, governmental entities will be unwilling to make lease payments 24 greater than the cost of obtaining the same amount of funds 20 through conventional debt instruments, such as issuing bonds. The cost of obtaining the funds 20 will be less than conventional debt instruments and will represent a theoretical cap on what the governmental entity 12 would be willing to pay in lease payments 24. From an investor's point of view, the present sale and lease-back system 10 pays a lower rate of return than a conventional government security, but provides an up-side potential not available with other government securities.

The one exception to this general rule is that as the governmental entity 12 issues more debt instruments, the incremental cost increases. That is, the more debt the governmental entity 12 incurs, the lower the credit rating for that governmental entity, and hence, the greater the cost of issuing debt instruments.

The general obligation lease of the present invention can be structured in a variety of ways. In one embodiment, the general obligation lease 22 is secured by contractual provisions in the lease document that pledge the taxing and borrowing power of a governmental entity to fulfilling the lease payments 24. The contractual provision may also grant the private entity 16 the right to bring actions against the governmental entity 12 in the event of disputes over the lease 22. In still another embodiment, the general obligation lease 22 is structured to comply with statutory provisions that allow the governmental entity 12 to pledge the full faith and credit of the governmental entity 12 to make lease payments to the private entity 16 on the lease 22.

In one embodiment of the general obligation lease 22 is secured and/or paid by a government credit instrument 32 guaranteeing the lease payments 24 under the lease 22 issued in favor of the private entity 16. The government credit instrument 32 guarantees that the governmental entity 12 will use every available means to ensure that it will honor the terms of the lease 22. The government credit instrument 32 is preferably a separate, fully negotiable, financial instrument pledging the full faith and credit of the governmental entity 12 to fulfill its obligations under the lease 22.

In one embodiment, the government credit instrument 32 is a security, such as a general obligation bond, for which the interest payments are in an amount and have due dates that correspond to the lease payments 24 under the lease 22. The interest payments on the government credit instrument 32 are used to make the lease payments 24. For example, the credit instrument 32 can be a general obligation coupon bond that pays the private entity 16 a specified amount of money at given dates until maturity. The given dates and the amounts paid preferably correspond to the due dates and the amounts of the lease payments. The face value of the bond at maturity is typically zero. In this embodiment, general obligation coupon bonds actually pay the lease payments 24 and are freely negotiable by the private entity 16. Since some or all of the coupons can be sold, the general obligation coupon bond embodiment provides the private entity 16 added liquidity.

In another embodiment, the credit instrument 32 can be general obligation zero coupon bonds. Zero coupon bonds are sold at a discount of the face value and mature at the face value. The governmental entity 12 can issue a series of general obligation zero coupon bonds with maturity dates and face values corresponding to the due date and amount of the lease payments 24. Again, the general obligation zero coupon bonds actually pay the lease payments 24 and are freely negotiable by the private entity 16. Under U.S. tax law, the imputed interest on a zero-coupon bond is taxable as it accrues, even though there is no cash flow. In order to make this embodiment more attractive to investors, the tax code will preferably be modified to exempt the imputed interest from tax liability until the bond is redeemed.

The general obligation lease 22 and/or the government credit instrument 32 preferably allow either the private entity 16 or the governmental entity 12 to transfer all or part of their interest in the private asset 26. For example, the governmental entity 12 may have a lease for the entire private asset 26. As the needs of the governmental entity 12 fluctuate, it may wish to utilize only a portion of the building for its own uses and sublease or assign a portion of its lease 22 obligations in the private asset 26 to a third party. In such an instance, the government credit instrument 32 may allow the governmental entity to engage in such activity, and provide a means for the governmental entity 12 to collect rent from the sublease or assignment. In the preferred embodiment, the full faith and credit of the governmental entity 12 backs the lease payments from the sublessee.

Further, it is possible, but not necessary, that the government credit instrument 32 may provide a means for the private entity 16 to share in any increased revenue that may be generated as a result of the sublease or assignment. In exchange, it is possible that the government credit instrument 32 may provide that the governmental entity 12 need only apply the full faith and credit for a portion of the lease payments 24 or duration of the lease.

The government credit instrument 32 also preferably permits the private entity 16 to transfer all or part of its rights in the private asset 26 and/or the lease 22 to a third party. For example, the private entity 16 may want to transfer the rights to some or all of the future lease payments 24 to a third party in exchange for a lump sum payment. In addition, the private entity 16 may want to sell its remainder interest in the private asset 26. The government credit instrument 32 may allow the private entity 16 to engage in some or all types of rights transfers, while pledging the full faith and credit of the governmental entity 12 to the lease payments 24.

In another embodiment, the portion of the private asset 26 leased by the governmental entity 12 may fluctuate over the life of the lease 22. The government credit instrument 32 can be structured to permit this fluctuation, while maintaining the full faith and credit guarantee on the lease payments 24.

It can be seen that a general obligation lease like the one described above would provide governmental entities 12 an opportunity to exploit the equity it has in various governmental assets 14. The general obligation lease 22 allows governmental entity 12 to retire debts, to provide services, and to reduce its illiquid assets without increasing the cost of obtaining capital. The general obligation lease 22 also allows a governmental entity to reduce the risk a potential investor may assume in a typical sale and lease-back arrangement, thereby allowing the governmental entity to lease the properties back at lower lease rates, while still providing an attractive investment alternative for private entities.

During times when interest rates are low, the lease payments 24 operate as a guaranteed stream of income to the private entity 16. During times of high interest rates, the appreciation of the underlying private asset 26 off-sets, at least in part, the opportunity cost of lease payments 24 that pay a return lower than prevailing rates. Thus, the present sale and lease-back system 10 provides a competitive return in a variety of market conditions with minimal risk.

Although the present invention has been described with reference to preferred embodiments, workers skilled in the art will recognize that changes may be made in form and detail without departing from the spirit and scope of the invention. In addition, the invention is not to be taken as limited to all of the details thereof as modifications and variations thereof may be made without departing from the spirit or scope of the invention.

What is claimed is:

1. A sale and lease-back system for governmental assets comprising:
a sales document transferring title of a governmental asset to a private entity in exchange for funds, the transfer of title converting the governmental asset into a private asset; and
a general obligation lease between the private entity and the governmental entity granting the governmental entity usage of at least a portion of the private asset in exchange for lease payments.

2. The system of claim 1 wherein the general obligation lease comprises a government credit instrument that pledges the full faith and credit of the governmental entity to make lease payments to the private entity on the general obligation lease.

3. The system of claim 2 wherein the government credit instrument comprises a plurality of zero coupon bonds with maturity dates and face values that correspond to the lease payments.

4. The system of claim 2 wherein the government credit instrument comprises a plurality of coupon bonds, wherein the coupons have maturity dates and face values that correspond to the lease payments.

5. The system of claim 2 wherein the government credit instrument is fully negotiable.

6. The system of claim 1 wherein the general obligation lease permits the private entity to transfer all or part of its rights in the private asset to a third party.

7. The system of claim 1 wherein the general obligation lease permits the private entity to transfer all or part of its rights in the general obligation lease to a third party.

8. The system of claim 1 wherein the general obligation lease permits the governmental entity to sublease a portion of the general obligation lease to a third party during the term of the general obligation lease.

9. The system of claim 1 wherein the general obligation lease comprises a statutory provision that pledges the full faith and credit of the governmental entity to make lease payments to the private entity on the general obligation lease.

10. The system of claim 1 wherein the general obligation lease comprises a provision of the general obligation lease that pledges the full faith and credit of the governmental entity to make lease payments to the private entity on the general obligation lease.

11. The system of claim 1 wherein the lease payments are determined by the interest rate costs of the funds instead of the fair market value of the governmental asset.

12. The system of claim 1 wherein the lease payments under the lease are less than debt service on a conventional government security yielding the same amount of funds obtained through the sale of the governmental asset.

13. The system of claim 1 wherein the funds equal the fair market value of the governmental asset.

14. The system of claim 1 wherein the funds are greater than or less than the fair market value of the governmental asset.

15. The system of claim 1 comprising a tax abatement agreement on the private asset.

16. The system of claim 1 comprising a tax abatement agreement on the private asset during a term of the general obligation lease.

17. The system of claim 1 comprising an agreement to waive or reduce tax liability on the lease payments.

18. The system of claim 1 comprising an agreement to waive or reduce tax liability on the lease payments during a term of the general obligation lease.

19. The system of claim 1 wherein the governmental entity applies the funds to general governmental expenditures.

20. The system of claim 1 wherein the governmental entity applies the funds to reduce governmental debt.

21. The system of claim 1 comprising equity instruments issued by the private entity to investors in exchange for capital contributions to the private entity.

22. The system of claim 1 wherein the private entity comprises a plurality of private entities.

23. The system of claim 1 wherein the general obligation lease comprises a sublease provision that permits the governmental entity to sublease a portion of the private asset to a third party and wherein the full faith and credit of the governmental entity is pledged to the lease payments made by the third party.

24. The system of claim 1 wherein the general obligation lease comprises a renewal option that permits the governmental entity to extend the general obligation lease for a period of time.

25. The system of claim 1 wherein the general obligation lease is for the entire private asset.

26. The system of claim 1 wherein the general obligation lease is at-will.

27. The system of claim 1 wherein the general obligation lease is for a term of years.

28. A sale and lease-back method for governmental assets, the method comprising the steps of:
transferring title of a governmental asset to a private entity in exchange for funds, the transfer of title converting the governmental asset into a private asset; and
executing a general obligation lease between the private entity and the governmental entity granting the governmental entity usage of at least a portion of the private asset in exchange for lease payments.

29. The method of claim 28 comprising the step of issuing a government credit instrument that pledges the full faith and credit of the governmental entity to make lease payments to the private entity on the general obligation lease.

30. The method of claim 29 wherein the government credit instrument comprises a plurality of zero coupon bonds with maturity dates and face values that correspond to the lease payments.

31. The method of claim 29 wherein the government credit instrument comprises a plurality of coupon bonds, wherein the coupons have maturity dates and face values that correspond to the lease payments.

32. The method of claim 29 wherein the government credit instrument is fully negotiable.

33. The method of claim 28 comprising the step of transferring some or all of the private asset to a third party.

34. The method of claim 28 comprising the step of transferring all or part of the rights in the general obligation lease to a third party.

35. The method of claim 28 wherein the governmental entity subleases a portion of the general obligation lease to a third party during the term of the general obligation lease.

36. The method of claim 28 comprising enacting a statutory provision that pledges the full faith and credit of the governmental entity to make lease payments to the private entity on the general obligation lease.

37. The method of claim 28 executing a general obligation lease provision that pledges the full faith and credit of the governmental entity to make lease payments to the private entity on the general obligation lease.

38. The method of claim 28 wherein the lease payments are determined by the interest rate costs of the funds instead of the fair market value of the governmental asset.

39. The method of claim 28 wherein the lease payments under the lease are less than debt service on a conventional government security yielding the same amount of funds obtained through the sale of the governmental asset.

40. The method of claim 28 wherein the funds equal the fair market value of the governmental asset.

41. The method of claim 28 wherein the funds are greater than or less than the fair market value of the governmental asset.

42. The method of claim 28 comprising the step of granting a tax abatement on the private asset.

43. The method of claim 28 comprising the step of granting a tax abatement on the private asset during a term of the general obligation lease.

44. The method of claim 28 comprising the step of waiving or reducing tax liability on the lease payments.

45. The method of claim 28 comprising the step of waiving or reducing tax liability on the lease payments during a term of the general obligation lease.

46. The method of claim 28 wherein the governmental entity applies the funds to general governmental expenditures.

47. The method of claim 28 wherein the governmental entity applies the funds to reduce governmental debt.

48. The method of claim 28 wherein the private entity issues equity instruments to investors in exchange for capital contributions to the private entity.

49. The method of claim 28 wherein the private entity comprises a plurality of private entities.

50. The method of claim 28 wherein the governmental entity sublease a portion of the private asset to a third party.

51. The method of claim 28 wherein the governmental entity renews the general obligation lease for a period of time.

52. The method of claim 28 comprising executing the general obligation lease for the entire private asset.

53. A sale and lease-back system for governmental assets comprising:
a sales document transferring title of a governmental asset to a private entity in exchange for funds, the transfer of title converting the governmental asset into a private asset; and
a general obligation lease between the private entity and the governmental entity granting the governmental entity usage of at least a portion of the private asset in exchange for lease payments, wherein the general obligation lease comprises the investment risk characteristics of a general obligation bond, but lease payments under the lease are less than the debt service on conventional government securities yielding the same amount of funds obtained through the sale of the governmental asset.
